(19) United States
(12) Patent Application Publication
(10) Pub. No.: US 2010/0098998 A1
(43) Pub. Date: Apr. 22, 2010

(54) ELECTROLYTE MEMBRANE, METHOD FOR PRODUCING THE SAME, AND MEMBRANE ELECTRODE ASSEMBLY

(76) Inventor: Hiroshi Suzuki, Aichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/529,728

(22) PCT Filed: Mar. 6, 2008
(86) PCT No.: PCT/JP2008/054557

§ 371 Date: Sep. 3, 2009

(30) Foreign Application Priority Data
Mar. 6, 2007 (JP) 2007-055446

(51) Int. Cl. H01M 8/08; B05D 5/00; H01M 8/04

(52) U.S. Cl. 429/33; 427/115

(57) ABSTRACT

An electrolyte membrane is obtained, by which formation of large stresses within the membrane due to swelling of the electrolyte membrane as a result of water absorption can be avoided in the operation of a fuel cell and with which a high-performance durable membrane electrode assembly can be produced. For this purpose, a fluorine-based electrolyte resin membrane 35 integrated with a porous reinforcing membrane 32 is subjected to hydrolysis to impart ion conductivity thereto. Through water absorption upon hydrolysis, a reinforcing membrane-integrated electrolyte resin membrane 35A caused to swell under regulation by the porous reinforcing membrane 32 is obtained. The thus swollen reinforcing membrane-integrated electrolyte resin membrane 35A is dried with its outer circumference fixed using a clamp 20 or the like, so as to form a water-free electrolyte membrane.

### TECHNICAL FIELD

The present invention relates to an electrolyte membrane to be used for producing a membrane electrode assembly for fuel cells, a method for producing the same, and the membrane electrode assembly.

### BACKGROUND ART

A polymer electrolyte fuel cell (PEFC) is known as one form of fuel cell. A polymer electrolyte fuel cell is expected as a power source for automobiles, and the like, because it can be operated at a lower temperature (approximately −30° C. to 120° C.) as compared with other forms of fuel cells and because it can also be reduced in cost and size.

A polymer electrolyte fuel cell, as shown in FIG. 7, comprises a membrane electrode assembly (MEA) 50 as a major component, which is placed between separators 51, which have fuel (hydrogen) gas channels and air gas channels, thus forming a single fuel cell 52 called “a single cell.” The membrane electrode assembly 50 comprises an electrolyte membrane (a solid polymer electrolyte membrane) 55, which is an ion exchange membrane, on one side of which an anode-side gas diffusion electrode 58a is formed in layers. The anode-side gas diffusion electrode 58a comprises an anode-side electrode catalyst layer 56a and a gas diffusion layer 57a. On the other side of the solid polymer electrolyte membrane 55, a cathode-side gas diffusion electrode 58b is formed in layers, which comprises a cathode-side electrode catalyst layer 56b and a gas diffusion layer 57b.

An electrolyte membrane in a membrane electrode assembly composing a fuel cell exhibits proton conductivity by absorbing water. Also, a resin composing an electrolyte membrane has a hydrophilic sulfonic acid group, so as to absorb a significant amount of water into the membrane. Thus, membrane swelling takes place, causing + directional dimensional changes in the in-plane direction or the direction of film thickness. When the water content percentage is reduced upon shutdown or the like, dimensional changes take place in the − direction. Among such dimensional changes, dimensional changes in the shrinking direction (− direction) can be easily regulated by devising the structure of a single cell. However, it is difficult to regulate dimensional changes in the + direction and particularly the extension side in the in-plane direction.

When dimensional changes take place due to swelling of an electrolyte membrane, problems tend to occur, such as development of wrinkles upon production of a membrane electrode assembly, accelerated deterioration in the membrane due to in-plane behavior, and peeling at the interface or initiation of cracks of the electrode catalyst layer due to differences in amount of change in swelling compared with the electrode catalyst layer. Hence, lowered performance or decreased durability of the membrane electrode assembly tends to take place.

As a measure against the above problems, Patent document 1 proposes a stretched electrolyte membrane, which is dried with its outer circumferential part fixed in a high-water-content state. The relevant facts used herein are as follows. The area is reduced upon drying of the membrane when the electrolyte membrane has a high water content. Accordingly, when the membrane with a high water content is dried with its outer circumferential part fixed, the membrane is dried while being stretched toward the outer circumference, so that the area of the membrane is increased relative to a case in which the membrane is dried without fixing. If the water content percentage of an electrolyte membrane is increased during electric power generation, the membrane does not swell to a greater extent than that of the initial state. Thus, damages to the membrane due to swelling are reduced.

Patent document 1: JP Patent Publication (Kokai) No. 2001-35510 A

### DISCLOSURE OF THE INVENTION

### Problems to be Solved by the Invention

The electrolyte membrane disclosed in Patent document 1 is advantageous in that if the water content percentage of an electrolyte membrane is increased during electric power generation, the membrane will never swell to an extent higher than the initial state. However, many treatment steps are required to obtain such electrolyte membrane. The present invention has been achieved in view of the above circumstances. An object of the present invention is to provide, with fewer treatment steps, an electrolyte membrane capable of suppressing its own swelling to a greater extent than that in its initial state due to water absorption during electric power generation and a method for producing the same. Also an object of the present invention is to provide a highly durable membrane electrode assembly having the above electrolyte membrane.

### Means for Solving the Problems

The present invention relates to a method for producing an electrolyte membrane to be used for producing a membrane electrode assembly for fuel cells, comprising the steps of:

impregnating, via melting, a porous reinforcing membrane with a fluorine-based electrolyte resin that is an electrolyte resin precursor having no ion conductivity, so as to form a fluorine-based electrolyte resin membrane integrated with a reinforcing membrane;
performing hydrolysis for imparting ion conductivity to the fluorine-based electrolyte resin by causing the thus obtained fluorine-based electrolyte resin membrane to a high-water-content state; and after hydrolysis,
drying the hydrolyzed membrane with the outer circumference fixed to result in a water-free state. Moreover, the present invention also discloses an electrolyte membrane that is produced by the above production method. Furthermore, the present invention also discloses a membrane electrode assembly having electrodes on both surfaces of the above electrolyte membrane. In addition, in each of the above inventions, any porous reinforcing membrane can be used and preferably a porous PTFE thin film is used.

In addition, the term “(step of) hydrolysis” in the present invention is meant to include both alkali treatment for substituting a terminal group of an electrolyte resin precursor, such as substitution of —SO₂F with —SO₃Na or —SO₃K and acid treatment for further substituting the substituted —SO₃Na terminal group or —SO₃K terminal group with —SO₃H.

In the production method according to the present invention, the hydrolysis step is performed for imparting ion conductivity to a fluorine-based electrolyte resin membrane integrated with a porous reinforcing membrane, and then the resultant is dried to form an electrolyte membrane. Swelling of an electrolyte resin upon hydrolysis is regulated by the behavior of the porous reinforcing membrane. Hence, the swelling in the planar direction can be suppressed, for example, to 20% or less through appropriate selection of a material for the porous reinforcing membrane. Swelling in the direction of film thickness can be suppressed, for example, to 50% or less, through the same. Furthermore, the swelling is maintained at almost the same level in the case of an electrolyte membrane dried to a water-free state with its outer circumference fixed. Compared with a production method that involves causing an electrolyte membrane to which ion conductivity has been imparted to have a high water content (%) and to swell in another step and then drying the membrane while holding it with a clamp or the like, production steps of the production method according to the present invention are simplified.

Moreover, the percentage of swelling in the in-plane direction of an electrolyte membrane that is produced by the above production method is almost the same as that in a water-free state. Also, when a membrane electrode assembly is produced using the thus obtained electrolyte membrane to form a fuel cell (single cell) and the electrolyte membrane has a high water content due to electric power generation, the electrolyte membrane will never swell to a greater extent than that of a water-free state. Therefore, the electrolyte membrane is released from stresses such as membrane swelling of a membrane edge part regulated by a single cell.

Furthermore, the extension (swelling) of an electrolyte membrane that is produced by the above method is regulated by a porous reinforcing membrane upon hydrolysis for imparting ion conductivity. Hence, gas permeability of the electrolyte membrane produced by the above method is suppressed to a greater size than that of an electrolyte membrane that is obtained by causing it to have a high water content and to swell after imparting of ion conductivity and then drying the membrane while maintaining its swollen state, as described in the following Examples. In this manner, durability of the thus produced membrane electrode assembly can be improved. Also, internal stresses within the membrane can be equalized through employment of a method that involves impregnating, via melting, a porous reinforcing membrane with a fluorine-based electrolyte resin that is an electrolyte resin precursor having no ion conductivity, so that the electrolyte membrane's own strength is stabilized and in-plane shrinkage stresses can be equalized. As a result, repeated water absorption by and drying of the electrolyte membrane makes it possible to suppress the occurrence of peeling between the reinforcing membrane and the electrolyte resin. Accordingly, the durability of an electrolyte membrane that is produced by the above method and the durability of a membrane electrode assembly produced using the electrolyte membrane are improved.

According to the present invention, an electrolyte membrane that will never swell upon electric power generation to a greater extent than that in its water-free state can be relatively easily produced. The durability of a membrane electrode assembly having the electrolyte membrane according to the present invention is significantly improved.

### BRIEF DESCRIPTION OF THE DRAWINGS

FIG. 1 is an explanatory drawing of the method for producing an electrolyte membrane according to the present invention in a sequential order of steps.

FIG. 2 is a schematic view showing a cross-section of a fluorine-based electrolyte resin membrane integrated with a reinforcing membrane.

FIG. 3 is an explanatory drawing of the state of the electrolyte membranes fixed with a clamp device in the Example and Comparative examples.

FIG. 4 is a graph showing gas permeability (%) of electrolyte membranes in the Example and Comparative examples.

FIG. 5 is a schematic view showing images of the electrolyte membranes in the Example and Comparative examples.

FIG. 6 is a graph showing the amount of change in gas leakage in the cases of the membrane electrode assemblies produced using the electrolyte membranes in the Example and Comparative examples.

FIG. 7 is an explanatory drawing of a fuel cell (single cell) and a membrane electrode assembly.

### DESCRIPTION OF SYMBOLS

20 . . . clamp device, 21 . . . clamp piece, 31 . . . fluorine-based electrolyte resin membrane comprising electrolyte resin precursor having no ion conductivity, 32 . . . porous reinforcing membrane (porous PTFE thin film), 33, 34 . . . heating plate, and 35 . . . reinforcing membrane-integrated fluorine-based electrolyte resin membrane

### BEST MODE OF CARRYING OUT THE INVENTION

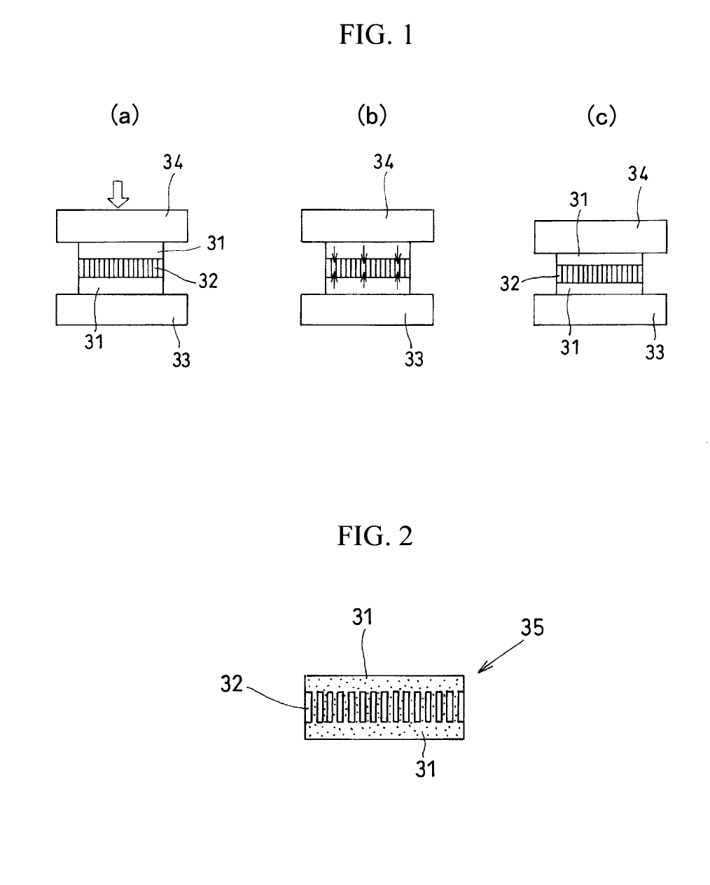

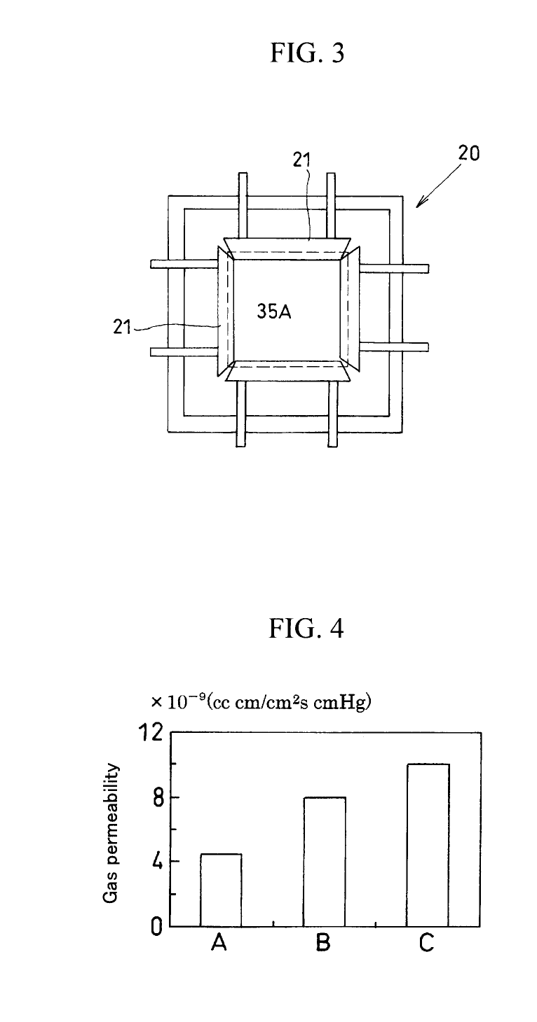

In the following, the electrolyte membrane and the production method according to the present invention are described by way of embodiments thereof with reference made to the drawings. FIG. 1 shows an example of the step of producing a reinforcing membrane-integrated fluorine-based electrolyte resin membrane prepared by impregnation of a porous reinforcing membrane with a fluorine-based electrolyte resin. FIG. 2 schematically shows an example of the thus produced reinforcing membrane-integrated fluorine-based electrolyte resin membrane. FIG. 3 shows an embodiment of drying of a hydrolyzed reinforcing membrane-integrated fluorine-based electrolyte resin membrane.

First, a fluorine-based electrolyte resin membrane 31 comprising an electrolyte resin precursor having no ion conductivity and a porous reinforcing membrane (in this Example, a porous PTFE thin film) 32 are prepared as starting materials. As shown in FIG. 1(a), the fluorine-based electrolyte resin membranes 31 are arranged above and below the porous reinforcing membrane 32, and then it is placed between heating plates 33 and 34. The heating plates 33 and 34 are heated and then kept at a temperature (20° C. to 280° C.) at which the fluorine-based electrolyte resin membrane 31 is melted.

Under such state, the heating plates 33 and 34 are slightly moved in a direction so that the width of holding (space between them) becomes narrower. Hence, as shown in FIG. 1 (b), the reinforcing membrane 32 is impregnated with the melted fluorine-based electrolyte resin. After impregnation, as shown in FIG. 1 (c), heating of the heating plates 33 and 34 is stopped, followed by cooling. After cooling, the heating plates 33 and 34 are opened, so that, as shown in FIG. 2, the porous reinforcing membrane impregnated with the fluorine-based electrolyte resin (a reinforcing membrane-integrated fluorine-based electrolyte resin membrane 35) is formed.

Next, to impart ion conductivity to a fluorine-based electrolyte resin which is an electrolyte membrane precursor, a hydrolysis step is performed by a conventionally known method for the thus obtained reinforcing membrane-integrated fluorine-based electrolyte resin membrane 35. Because of water absorption upon hydrolysis, both the electrolyte resin and the porous reinforcing membrane 32 swell, but the swelling is regulated by the behavior of the porous reinforcing membrane 32. For example, when a porous PTFE thin film is used as the reinforcing membrane 32, the swelling (%) in the planar direction can be suppressed to 20% or less and the swelling (%) in the direction of film thickness can be suppressed to 50% or less, for example.

Subsequently, washing with water, sulfuric acid immersion, or the like is performed, if necessary. Finally, as shown in FIG. 3, the outer circumference of a reinforcing membrane-integrated fluorine-based electrolyte resin membrane 35A to which ion conductivity has been imparted is fixed using an appropriate means, such as by holding the outer circumference using clamp pieces 21 of a clamp 20. Then, the reinforcing membrane-integrated fluorine-based electrolyte resin membrane 35A is subjected to drying in such state. Therefore, the electrolyte membrane according to the present invention is formed while regulating the behavior of the above porous reinforcing membrane 32 and maintaining the swelling that has taken place upon the above hydrolysis. The swelling is then maintained almost unchanged in the case of the electrolyte membrane dried to a water-free state.

Swelling (extension) of the electrolyte membrane according to the present invention, which is obtained by the above production method, is regulated by the porous reinforcing membrane 32 as described above. Hence, the electrolyte membrane has gas permeability that is suppressed to a greater extent than that in the case of an electrolyte membrane obtained by causing it (to which ion conductivity has been imparted) to have a high water content and to swell and then drying the electrolyte membrane while maintaining its swollen state. Thus, the durability of the thus produced membrane electrode assembly can be improved. Also, a method that involves impregnating, via melting, the porous reinforcing membrane 32 with a fluorine-based electrolyte resin is employed, so that internal stresses within the membrane can be equalized, the electrolyte membrane's own strength can be stabilized, and the in-plane shrinkage stresses can be equalized. As a result, even if water absorption by and drying of the electrolyte membrane take place repeatedly, peeling between the porous reinforcing membrane 32 and the electrolyte resin can be suppressed. Therefore, the durability of the membrane electrode assembly having the electrolyte membrane according to the present invention can be improved.

### EXAMPLES

An electrolyte membrane A obtained by the production method explained based on FIGS. 1 to 3 and the properties of a membrane electrode assembly produced using the same can be explained with reference to Comparative examples.

### Example 1

A porous PTFE thin film with a film thickness of 10 μm and porosity of 80% was used as a porous reinforcing membrane. An electrolyte membrane A with an EW value of 1000 and a film thickness of 40 μm was obtained by the above production method. The percentage of swelling was found to be 5% or less.

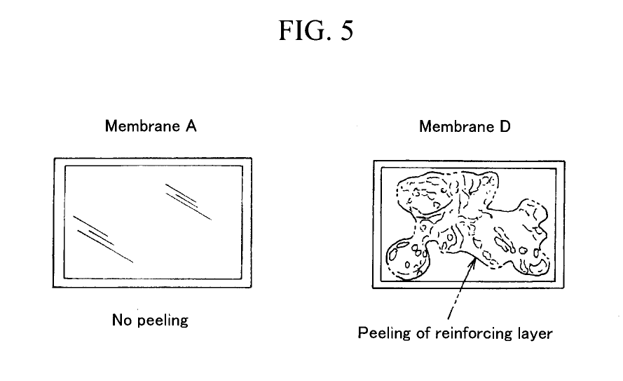

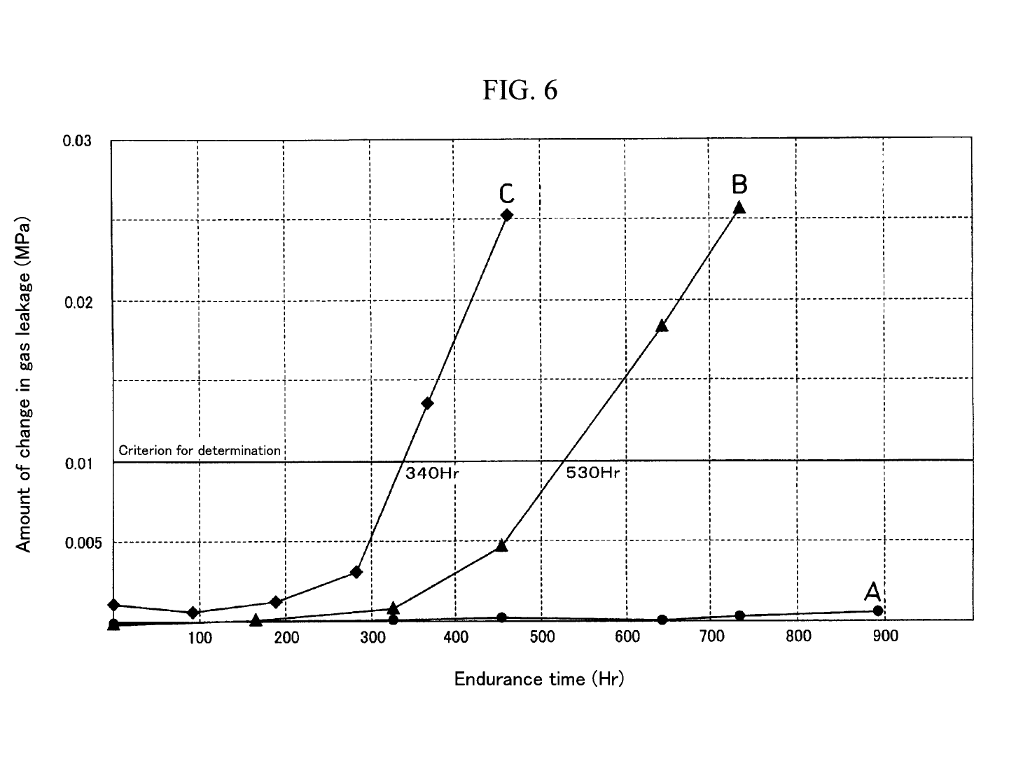

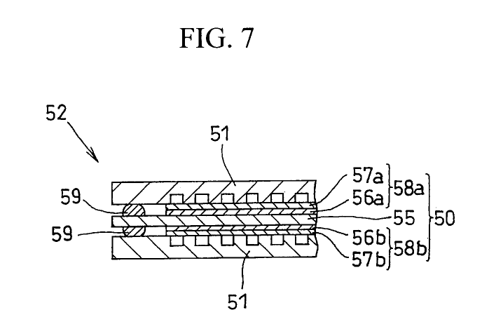

Test 1: Gas permeability (%) of the electrolyte membrane A was evaluated by supplying hydrogen (80° C. and humidity of 20%) at a fixed rate of 20 cc/min to one surface of an electrolyte membrane and then evaluating the gas permeability (%) based on the leakage amount when vacuum suction was performed on the opposite surface side. The result is shown as “A” in the graph of FIG. 4.
Test 2: A test was conducted by which a cycle of impregnating the electrolyte membrane A with hot water at 90° C. for 2 hours→drying the membrane A for 1 hour was repeated 300 times. After the test, the electrolyte membrane A was placed on a white substrate, an image was taken from above, and then peeling was evaluated. The image is shown as “membrane A” in FIG. 5.
Test 3: A membrane electrode assembly was produced by a conventional method using the electrolyte membrane A. The amount of change in gas leakage (MPa) during electric power generation (endurance time) was measured. The results are shown as “A” in FIG. 6.

### Comparative Example 1

A hydrolyzed H-type electrolyte resin (approximately 20 wt %) having ion conductivity was dissolved in an alcohol solution. A porous PTFE thin film with a film thickness of 10 μm and porosity of 80% was coated with the solution and then dried repeatedly. Thus, an electrolyte membrane B referred to as a cast molded membrane with an EW value of 1000 and a film thickness of 40 μm was obtained. The swelling (%) was found to be almost 10%.

Test 1: The gas permeability (%) of the electrolyte membrane B was measured and evaluated in a manner similar to that in Example 1. The result is shown as “B” in the graph in FIG. 4.
Test 3: A membrane electrode assembly was produced in a manner similar to that in Example 1, except that the electrolyte membrane B was used. The amounts of changes in gas leakage (MPa) during electric power generation (endurance time) were measured in a manner similar to that in Example 1. The result is shown as “B” in FIG. 6.

### Comparative Example 2

A hydrolyzed H-type electrolyte resin (approximately 20 wt %) having ion conductivity was dissolved in an alcohol solution. A protective sheet was coated with the solution and then dried repeatedly, so that an electrolyte membrane was obtained. The membrane was allowed to swell in its full water absorption state without any restriction. Outer circumferential four (4) sides of the thus swollen electrolyte membrane were fixed and held using clamp pieces 21 of a clamp device 20, as shown in FIG. 3. Under such state, the membrane was dried at normal temperature (25° C.) to its water-free state. Thus, an electrolyte membrane C with an EW value of 1000 and a film thickness of 40 μm was obtained. The swelling (%) was found to be almost 15%.

Test 1: The gas permeability (%) of the electrolyte membrane C was measured and evaluated in a manner similar to that in Example 1. The result is shown as “C” in the graph in FIG. 4.
Test 3: A membrane electrode assembly was produced in a manner similar to that in Example 1, except that the electrolyte membrane C was used. The amount of change in gas leakage (MPa) during electric power generation (endurance time) was measured in a manner similar to that in Example 1. The result is shown as “C” in FIG. 6.

### Comparative Example 3

A hydrolyzed H-type electrolyte resin (approximately 20 wt %) having ion conductivity was dissolved in an alcohol solution. A porous PTFE thin film with a film thickness of 10 μm and porosity of 80% was coated with the solution and then dried repeatedly, so that an electrolyte membrane was obtained. The membrane was immersed in hot water (80° C.) and then caused to swell to a 100% water absorption state without restriction. The thus swollen electrolyte membrane was fixed and held using a clamp device 20 in a manner similar to that in [Comparative example 2]. Under such state, the membrane was dried at normal temperature (25° C.) to its water-free state, so that an electrolyte membrane D was obtained. The electrolyte membrane D was subjected to evaluation of peeling in a manner same as that in Example 1. The image is shown as “membrane D” in FIG. 5 (Test 2).

### [Evaluation]

Test 1: As shown in FIG. 4, the membrane in Example 1 (the electrolyte membrane A according to the present invention) exhibited gas permeability (%) (leakage amount) lower than that in Comparative example 1 (electrolyte membrane B) and Comparative example 2 (electrolyte membrane C). This may be because hydrolysis performed for imparting ion conductivity to the reinforcing membrane (porous PTFE thin film) impregnated, via melting, with the fluorine-based electrolyte resin resulted in regulation of swelling of the electrolyte resin due to water absorption by the porous PTFE thin film.
Test 2: In the image of membrane A in FIG. 5, the white substrate directly appears since the membrane (the electrolyte membrane A according to the present invention) undergoing no peeling and being substantially plane. In contrast, in the image of membrane D, peeling took place in Comparative example 3 (electrolyte membrane D) and the regions (regions enclosed by dotted lines) are shown up in the image. In Example 1 (the electrolyte membrane A according to the present invention), a method that involves impregnating, via melting, a porous reinforcing membrane with a fluorine-based electrolyte resin; that is an electrolyte resin precursor, having no ion conductivity was employed, as described above. Hence, internal stresses within the membrane could be equalized compared with that in Comparative example 3 (electrolyte membrane D).
Test 3: The swelling (%) of the membrane in Example 1 (the electrolyte membrane A according to the present invention) was 5% or less, which was lower than that of the electrolyte membrane B in Comparative example 1 and the electrolyte membrane C in Comparative example 2. Accordingly, as shown in FIG. 6, the amount of change in gas leakage of the membrane electrode assembly produced using the electrolyte membrane A according to the present invention was extremely small even after 900 hours. The amount of change in gas leakage of the membrane electrode assembly produced using the electrolyte membrane B in Comparative example 1 exceeded 0.01 MPa (the criterion for determination in an endurance test) after almost 530 hours. The same of the membrane electrode assembly produced using the electrolyte membrane C in Comparative example 2 exceeded 0.01 MPa after almost 340 hours. The effectiveness of the electrolyte membranes obtained by the production method according to the present invention was demonstrated again.

1. A method for producing an electrolyte membrane to be used for producing a membrane electrode assembly for a fuel cell, comprising the steps of:
impregnating, via melting, a porous reinforcing membrane with a fluorine-based electrolyte resin that is an electrolyte resin precursor having no ion conductivity, so as to form a fluorine-based electrolyte resin membrane integrated with a reinforcing membrane;
performing hydrolysis for imparting ion conductivity to the fluorine-based electrolyte resin by causing the thus obtained fluorine-based electrolyte resin membrane to a high-water-content state; and after hydrolysis,
drying the membrane with the outer circumference fixed to result in a water-free state.

2. The method for producing an electrolyte membrane according to claim 1, wherein the hydrolysis step comprises both alkali treatment for substituting a terminal group of the electrolyte resin precursor, such as —SO₂F, with —SO₃Na or —SO₃K and acid treatment for further substituting the substituted —SO₃Na terminal group or —SO₃K terminal group with —SO₃H.

3. The method for producing an electrolyte membrane according to claim 1, wherein a porous PTFE thin film is used as the porous reinforcing membrane.

4. An electrolyte membrane to be used for producing a membrane electrode assembly for a fuel cell, which is prepared by impregnating, via melting, a porous reinforcing membrane with a fluorine-based electrolyte resin that is an electrolyte resin precursor having no ion conductivity, performing hydrolysis for imparting ion conductivity to the thus obtained fluorine-based electrolyte resin membrane integrated with the reinforcing membrane, and then drying the membrane while fixing the outer circumference.

5. A membrane electrode assembly, having electrodes on both surfaces of the electrolyte membrane according to claim 4.
